(19) United States
(12) Patent Application Publication
(10) Pub. No.: US 2022/0156052 A1
(43) Pub. Date: May 19, 2022

(54) SOFTWARE PACKAGING DEVICE AND METHOD FOR PERFORMING BINARY ANALYSIS, AND RECORDING MEDIUM ON WHICH PROGRAM FOR PERFORMING THE SAME IS RECORDED

(71) Applicant: Foundation of Soongsil University-Industry Cooperation, Seoul (KR)

(72) Inventors: Souhwan Jung, Seoul (KR); Ngoc-Tu Chau, Seoul (KR); Hyunseok Shim, Seoul (KR)

(21) Appl. No.: 17/472,773

(22) Filed: Sep. 13, 2021

(30) Foreign Application Priority Data
Nov. 19, 2020 (KR) 10-2020-0155892
Jan. 26, 2021 (KR) 10-2021-0010877

(51) Int. Cl. G06F 8/61

(52) U.S. Cl. CPC G06F 8/64

(57) ABSTRACT

Provided is a software packaging device, which sets an initial environment, migrates software information used by a target software to the initial environment, collects hardware information from an operation system at which the software is installed, applies the hardware information to the initial environment, and generates a software package from the initial environment to which the software information and the hardware information are applied.

### CROSS-REFERENCE TO RELATED APPLICATION

This application claims priority to Korean Patent Application No. 10-2020-0155892, filed on Nov. 19, 2020, and Korean Patent Application No. 10-2021-0010877, filed on Jan. 26, 2021, and all the benefits accruing therefrom under 35 U.S.C. § 119, the contents of which in its entirety are herein incorporated by reference.

### BACKGROUND

### 1. Field

The present disclosure relates to a software packaging device and method for performing binary analysis, and more particularly, to a software packaging device and method for generating a software package by packaging software.

### 2. Description of the Related Art

A package refers to an installation file provided so that a user may easily install and configure software, and includes information and setting of the software, an execution file, and the like. The execution file refers to a file that contains code and data header information for executing the software and uses a format such as COFF (Common Object File Format), PE (Portable Executable), and ELF (Executable and Linkable Format), depending on an operation system. The code refers to a machine language that a CPU can understand and is generated from high-level source code such as C or C++ at the time of compiling.

Meanwhile, virtualization technology is being developed for computing resources in all fields, and has been successfully applied to high-performance server devices in data centers of Internet portal companies or the like. The virtualization technology is a technology that can be widely applied not only for servers and storage in data centers, but also for networking equipment such as routers for transmission and user terminals such as PCs, PDAs, and smartphones. The virtualization technology may also be used as a technology for future embedded devices, such as smart gateway devices for vehicles, smart home gateway devices, and non-stop routers for future networks. The virtualization technology as above is provided in the form of installing a virtual operation system on an operation system actually installed in hardware, and for this, the virtualization technology uses a virtual machine such as a hypervisor for information exchange between an actual operation system and a virtual operation system.

In this regard, conventionally, packages are generated so as to be driven only in a specific operation system, and accordingly, there is a difficulty in applying the virtualization technology in order to use packages available in other operation systems in a specific operation system. Also, there exists a method of including a hardware layer as well as an image layer of software in the package, but in such method, there is a disadvantage in that the package becomes large. Accordingly, there is a need for a method of generating a reduced package while including an image layer and a hardware layer.

### SUMMARY

The present disclosure is directed to providing a software packaging device and method for packaging software by analyzing commands expressed by binary values from software.

In one aspect of the present disclosure, there is provided a software packaging device, comprising: an environment setting unit configured to set an initial environment; a software information control unit configured to extract software information used by a preset target software and migrate the software information to the initial environment; a hardware information collecting unit configured to collect hardware information from an operation system at which the software is installed; a hardware information control unit configured to apply the hardware information to the initial environment; and a package generating unit configured to generate a software package from the initial environment to which the software information and the hardware information are applied.

In addition, the environment setting unit may be configured to generate a plurality of preset basic folders such that the initial environment is set.

In addition, the basic folders may include a binary folder, a device folder, a library folder, a variable folder and a super binary folder.

In addition, the software information control unit may be configured to extract meta information of the target software and extract software information identical to software information recorded in the meta information from the target software.

In addition, the software information control unit may be configured to migrate the software information to a basic folder set in the initial environment to be matched with a location of the software information extracted from the target software.

In addition, the hardware information collecting unit may be configured to extract a call command provided to be performed by the target software and collect configuration information of the operation system called by the call command and profile information of the operation system required for operating the target software.

In addition, the hardware information control unit may be configured to update the initial environment to which the software information is applied, based on the hardware information collected from the operation system.

In another aspect of the present disclosure, there is also provided a software packaging method in a software packaging device for performing binary analysis, comprising: by an environment setting unit, setting an initial environment; by a software information control unit, extracting software information used by a preset target software and migrating the software information to the initial environment; by a hardware information collecting unit, collecting hardware information from an operation system at which the software is installed; by a hardware information control unit, applying the hardware information to the initial environment; and by a package generating unit, generating a software package from the initial environment to which the software information and the hardware information are applied.

In addition, the step of setting an initial environment may include generating a plurality of preset basic folders such that the initial environment is set.

In addition, the basic folders may include a binary folder, a device folder, a library folder, a variable folder and a super binary folder.

In addition, the step of extracting software information and migrating the software information to the initial environment may include extracting meta information of the target software and extracting software information identical to software information recorded in the meta information from the target software.

In addition, the step of extracting software information and migrating the software information to the initial environment may include migrating the software information to a basic folder set in the initial environment to be matched with a location of the software information extracted from the target software.

In addition, the step of collecting hardware information from an operation system may include extracting a call command provided to be performed by the target software and collecting configuration information of the operation system called by the call command and profile information of the operation system required for operating the target software.

In addition, the step of applying the hardware information to the initial environment may include updating the initial environment to which the software information is applied, based on the hardware information collected from the operation system.

In still another aspect of the present disclosure, there is also provided a computer-readable recording medium on which a computer program for performing the software packaging method is recorded.

According to one aspect of the present disclosure described above, by providing the software packaging device and method for performing binary analysis, it is possible to package software by analyzing commands expressed by binary values from the software.

### BRIEF DESCRIPTION OF THE DRAWINGS

FIG. 1 is a schematic diagram showing a software packaging system including a software packaging device according to an embodiment of the present disclosure.

FIG. 2 is a control block diagram showing the software packaging device according to an embodiment of the present disclosure.

FIG. 3 is a block diagram showing a process of processing a software package by the package generating unit of FIG. 2.

FIG. 4 is a schematic diagram exemplarily showing a process of generating a software package by the software packaging device according to an embodiment of the present disclosure.

FIG. 5 is a flowchart for illustrating a software packaging method according to an embodiment of the present disclosure.

### DETAILED DESCRIPTION

The following detailed description of the present disclosure refer to the accompanying drawings that exemplarily illustrate specific embodiments in which the present disclosure may be implemented. These embodiments are described in sufficient detail to enable a person skilled in the art to practice the present disclosure. It should be understood that various embodiments of the present disclosure are different but need not be exclusive from each other. For example, specific shapes, structures and characteristics described herein may be implemented in other embodiments without departing from the idea and scope of the present disclosure in relation to one embodiment. In addition, it should be understood that locations or arrangement of individual components in each disclosed embodiment may be changed without departing from the idea and scope of the present disclosure. Accordingly, the following description is not intended to limit the scope, and the scope of the present disclosure, if properly described, is limited only by the appended claims, along with all scopes equivalent to the features defined in the claims. Like reference numerals in the drawings indicate the same or similar functions over several aspects.

Hereinafter, the term “unit” is defined herein as having its broadest definition to ordinary skill in the art to refer to software including instructions executable in a non-transitory computer-readable medium that would perform the associated function when executed, a circuit or a processor designed to perform the associated function, hardware designed to perform the associated function, or a combination of them.

Further, it is to be understood that all detailed descriptions mentioning specific embodiments of the present disclosure as well as principles, aspects, and embodiments of the present disclosure are intended to include structural and functional equivalences thereof. Further, it is to be understood that these equivalences include an equivalence that will be developed in the future as well as an equivalence that is currently well-known, that is, all elements invented so as to perform the same function regardless of a structure.

Therefore, it is to be understood that, for example, block diagrams of the present specification illustrate a conceptual aspect of an illustrative circuit for embodying a principle of the present disclosure. Therefore, it is to be understood that all flow charts, state transition diagrams, pseudo-codes, and the like, illustrate various processes that may be tangibly embodied in a computer-readable medium and that are executed by computers or processors regardless of whether or not the computers or the processors are clearly illustrated.

Functions of various elements including processors or functional blocks represented as concepts similar to the processors and illustrated in the accompanying drawings may be provided using hardware having capability to execute software in connection with appropriate software as well as dedicated hardware. When the functions are provided by the processors, they may be provided by a single dedicated processor, a single shared processor, or a plurality of individual processors, and some of them may be shared with each other.

In addition, the explicit use of terms presented as the processor, control, or similar concepts should not be interpreted exclusively by quoting hardware capable of executing software, but should be understood to implicitly include, without limitation, digital signal processor (DSP) hardware, a ROM for storing software, a RAM, and a non-volatile memory. The above-mentioned terms may also include well-known other hardware.

In the claims of the present specification, components represented as means for performing functions mentioned in a detailed description are intended to include all methods for performing functions including all types of software including, for example, a combination of circuit devices performing these functions, firmware/micro codes, or the like, and are coupled to appropriate circuits for executing the software so as to execute these functions. It is to be understood that since functions provided by variously mentioned means are combined with each other and are combined with a method demanded by the claims in the present disclosure defined by the claims, any means capable of providing these functions are equivalent to means recognized from the present specification.

Hereinafter, preferred embodiments of the present disclosure will be described in more detail with reference to the drawings.

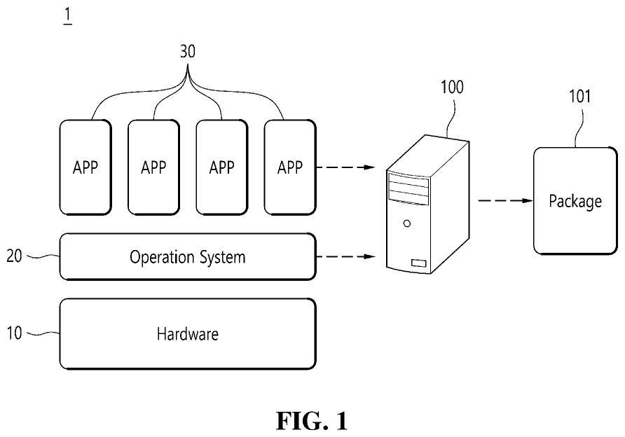

FIG. 1 is a schematic diagram showing a software packaging system including a software packaging device according to an embodiment of the present disclosure.

A software packaging device 100 may generate a software package 101 from a target software (a software) 30 installed at an operation system 20.

To this end, the software packaging device 100 may extract software information from the target software 30, and the software packaging device 100 may collect hardware information from the operation system 20.

Here, the operation system 20 may refer to an OS (Operating System) provided for a user to use hardware 10 and software 30, and, for example, the operation system 20 may include Linux, Ubuntu, Windows, and the like. In addition, the software 30 may refer to an application program, an application, and the like.

Accordingly, the software 30 may be provided to be installed at the operation system 20, and the software 30 may be provided to control the hardware 10 through the operation system 20 or to use resources of the hardware 10 through the operation system 20.

To this end, the operation system 20 may be stored in a storage place of the hardware 10, and the software 30 may be stored in a storage place at which the operation system 20 is installed.

At this time, when the operation system 20 is stored in the storage place, it may be understood as hardware information such as a file required for operating the operation system 20, a file generated while the operation system 20 is operating, and a file indicating the hardware 10 at which the operation system 20 is installed is stored in the storage place.

In other words, the hardware information may include a file required for operating the operation system 20, a file generated while the operation system 20 is operating, and a file indicating the hardware 10 at which the operation system 20 is installed.

Here, the hardware information may include configuration information and profile information. The configuration information may include a file required for operating the operation system 20 or a file generated while the operation system 20 is operating, and the profile information may include a file indicating the hardware 10 at which the operation system 20 is installed, and the like.

In addition, when the software 30 is stored in the storage place, it may be understood as software information such as a file required for operating the software 30 and a file generated while the software 30 is operating is stored in the storage place.

In other words, the software information may include a file required for operating the software 30 or a file generated while the software 30 is operating.

For example, the software information may include a log file, a spooling file, a binary file, a library file, and the like.

In this case, the software information may be provided by applying some or all of the hardware information. For example, the binary file of the software information may include at least one command used in the operation system 20 according to the hardware information, and the log file of the software information may be provided such that profile information according to the hardware information is listed.

Meanwhile, the software packaging device 100 may set any one of a plurality of software 30 installed at the operation system 20 as the target software, and accordingly, the software packaging device 100 may generate the software package 101 based on the target software.

Here, the software package 101 may be provided to install or distribute the software 30, and, for this purpose, the software package 101 may be generated in the form of a compressed file or an application program file by the software packaging device 100.

For example, the software package 101 may be generated in the form of an APK (Android Application Package), an RPM (Red Hat Package Manager), and an exe (Executable) file.

In this regard, the software package 101 may be generated to be executable in a hypervisor-based virtual machine, or the software package 101 may be generated to be executable in a container-based virtual machine.

Through this, the software packaging device 100 may give an effect of converting a conventional large system for the software 30 into the software package 101 including an image layer (an image profile) and a hardware layer (a kernel and hardware profile).

In this way, the software packaging device 100 may generate a software package by analyzing commands expressed as binary values according to the software 30, and hereinafter, the software packaging device 100 according to an embodiment of the present disclosure will be described in detail.

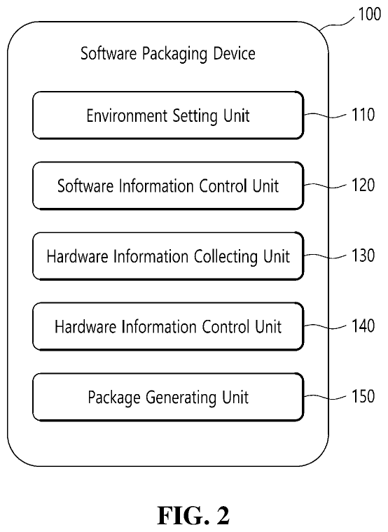

FIG. 2 is a control block diagram showing the software packaging device according to an embodiment of the present disclosure.

The software packaging device 100 may include an environment setting unit 110, a software information control unit 120, a hardware information collecting unit 130, a hardware information control unit 140, and a package generating unit 150.

In addition, the software packaging device 100 may be implemented by more components than the components shown in FIG. 2, and may be implemented by fewer components than that. Alternatively, in the software packaging device 100, at least two components provided in the software packaging device 100 may be integrated into one component, so that one component may perform a complex function. Hereinafter, the above-described components will be described in detail.

The environment setting unit 110 may set an initial environment. Here, the initial environment may refer to an environment in which the software 30 is installed according to the operation system 20, and accordingly, the initial environment may refer to a plurality of basic folders generated based on the operation system 20.

For example, if the operation system 20 is Linux, the basic folders may include a binary folder, a device folder, a library folder, a variable folder, and a super binary folder, and such a basic folder may vary depending on the operation system 20 installed at the hardware 10.

In this way, the environment setting unit 110 may generate a plurality of preset basic folders to set the initial environment.

In an embodiment, the environment setting unit 110 may be provided to build a slim system based on a scratch environment (or, an empty environment), and the slim system as above may be generated in a BusyBox-based structure

The software information control unit 120 may extract software information used by a preset target software, and the software information control unit 120 may migrate the extracted software information to the initial environment.

To this end, the software information control unit 120 may extract meta information of the target software, and the software information control unit 120 may extract software information identical to software information recorded in the meta information from the target software.

Here, the meta information may include information of structure, form, location, or the like for software information used or generated by the software 30, and in an embodiment, the meta information may refer to an i-node used in a Linux operation system.

As such, the software information control unit 120 may extract software information from the target software based on the meta information.

In one embodiment, if the operation system 20 is Linux, the software information control unit 120 may statically collect software information using a Linux package or library management tool.

Accordingly, the software information control unit 120 may migrate the software information to a basic folder set in the initial environment to be matched with a location of the software information extracted from the target software.

For example, the software information control unit 120 may migrate the software information extracted from the binary folder of the target software to a binary folder set in the initial environment, and the software information control unit 120 may migrate the software information extracted from the device folder of the target software to a device folder set in the initial environment.

The hardware information collecting unit 130 may collect hardware information from the operation system 20 at which software 30 is installed.

To this end, the hardware information collecting unit 130 may extract a call command provided to be performed by the target software, and the hardware information collecting unit 130 may collect configuration information of the operation system 20 called by the call command and profile information of the operation system 20 required for operating the target software.

Here, the call command may refer to a command provided for the target software to control the hardware 10.

Accordingly, the hardware information collecting unit 130 may collect hardware information according to the call command of the target software. In this case, the hardware information collecting unit 130 may collect the hardware information by performing static analysis on the target software, and the hardware information collecting unit 130 may collect the hardware information by performing dynamic analysis on the target software.

The hardware information control unit 140 may apply the hardware information to the initial environment, and for this, the hardware information control unit 140 may update the initial environment to which the software information is applied, based on the hardware information collected from the operation system 20.

In other words, the hardware information control unit 140 may extract software information in which the hardware information is set among software information applied to the initial environment, and update the hardware information set in the extracted software information to the collected hardware information.

In addition, the hardware information control unit 140 may migrate the hardware information collected from the operation system 20 to the initial environment to which the software information is applied.

The package generating unit 150 may generate the software package 101 from the initial environment to which the software information and the hardware information are applied.

Accordingly, the software package 101 may be generated to include a preset target software among a plurality of software 30 installed at the operation system 20.

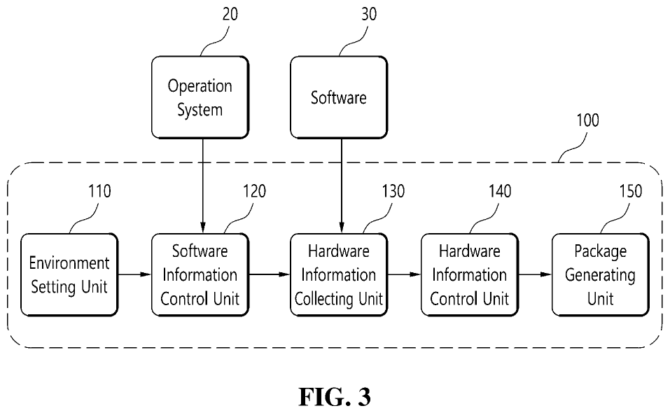

FIG. 3 is a block diagram showing a process of processing a software package by the package generating unit of FIG. 2.

Referring to FIG. 3, the environment setting unit 110 may set an initial environment. To this end, the environment setting unit 110 may generate a plurality of preset basic folders to set an initial environment.

The software information control unit 120 may extract software information used by a preset target software, and the software information control unit 120 may migrate the extracted software information to the initial environment.

To this end, the software information control unit 120 may extract meta information of the target software, and the software information control unit 120 may extract software information identical to software information recorded in the meta information from the target software.

Accordingly, the software information control unit 120 may migrate the software information to a basic folder set in the initial environment to be matched with a location of the software information extracted from the target software.

The hardware information collecting unit 130 may collect hardware information from the operation system 20 at which the software 30 is installed.

To this end, the hardware information collecting unit 130 may extract a call command provided to be performed by the target software, and the hardware information collecting unit 130 may collect configuration information of the operation system 20 called by the call command and profile information of the operation system 20 required for operating the target software.

The hardware information control unit 140 may apply the hardware information to the initial environment, and for this, the hardware information control unit 140 may update the initial environment to which the software information is applied, based on the hardware information collected from the operation system 20.

The package generating unit 150 may generate a software package 101 from the initial environment to which the software information and the hardware information are applied.

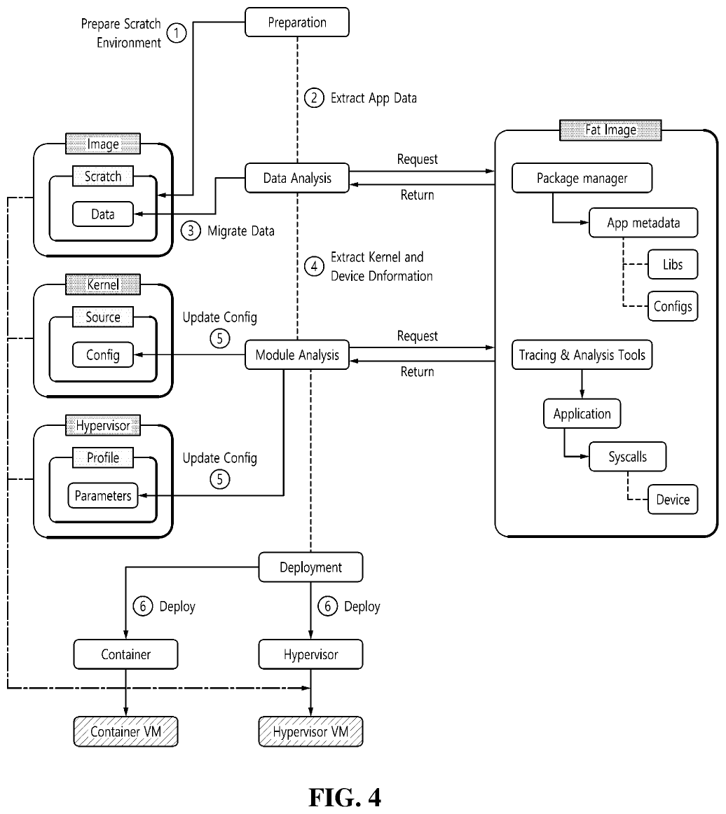

Meanwhile, FIG. 4 is a schematic diagram exemplarily showing a process of generating a software package by the software packaging device according to an embodiment of the present disclosure.

In one embodiment as above, the software packaging device 100 may extract software information and hardware information from a FAT (File Allocation Table) image at which the target software is installed, and the software packaging device 100 may generate a software package 101 by extracting the software information and the hardware information extracted from the initial environment.

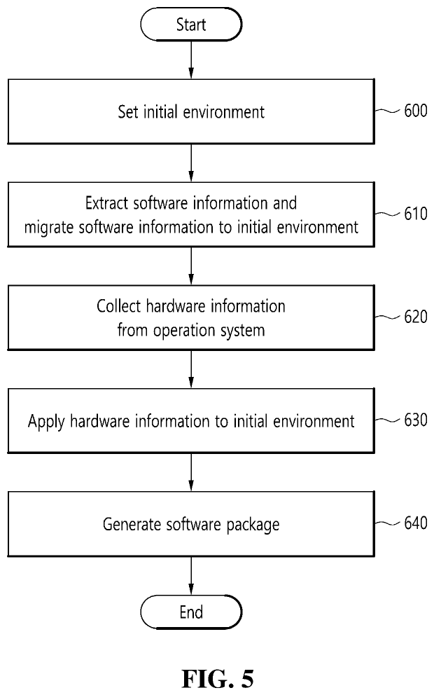

FIG. 5 is a flowchart for illustrating a software packaging method according to an embodiment of the present disclosure.

The software packaging method according to an embodiment of the present disclosure is performed on substantially the same configuration as the software packaging device 100 shown in FIG. 1, so like reference numerals are given to like components of the software packaging device 100 of FIG. 1 and are not described in detail again.

The software packaging method may include the steps of setting an initial environment (600), extracting software information and migrating the software information to the initial environment (610), collecting hardware information from an operation system (620), applying the hardware information to the initial environment (630), and generating a software package (640).

The step of setting an initial environment (600) may be a step in which the environment setting unit 110 sets an initial environment.

The step of extracting software information and migrating the software information to the initial environment (610) may be a step in which the software information control unit 120 extracts software information used by a preset target software and migrates the software information to the initial environment.

The step of collecting hardware information from an operation system (620) may be a step in which the hardware information collecting unit 130 collects hardware information from the operation system 20 at which the software 30 is installed.

The step of applying the hardware information to the initial environment (630) may be a step in which the hardware information control unit 140 applies the hardware information to the initial environment.

The step of generating a software package (640) may be a step in which the package generating unit 150 generates a software package 101 from the initial environment to which the software information and the hardware information are applied.

The software packaging method as described above may be implemented as an application or in the form of program commands that may be executed through various computer components, and may be recorded in a computer-readable recording medium. The computer-readable recording medium may include a program command, a data file, a data structure, or the like alone or in combination.

The program commands recorded in the computer-readable recording medium may be specially designed and constructed for the present disclosure and may be already known to and usable by those skilled in the computer software field.

Examples of the computer-readable recording medium include magnetic media such as hard disks, floppy disks and magnetic tapes, optical recording medium such as CD-ROMs and DVDs, magnetic-optical media such as floptical disks, and hardware devices specially configured to store and execute program commands such as ROM, RAM and flash memories.

Examples of the program command include not only machine language codes produced by a compiler but also high-level language codes that may be executed by a computer using an interpreter or the like. The hardware device may be configured to operate as one or more software modules to perform the processing according to the present disclosure, or vice versa.

Although the present disclosure has been described with reference to embodiments, it would be understood that various modifications and changes can be made by those skilled in the art from the present disclosure without departing from the idea and scope defined in the appended claims.

### REFERENCE SIGNS

1: software packaging system

10: hardware

20: operation system

30: software

100: software packaging device

101: software package

What is claimed is:

1. A software packaging device, comprising:
an environment setting unit configured to set an initial environment;
a software information control unit configured to extract software information used by a target software and migrate and apply the software information to the initial environment;
a hardware information collecting unit configured to collect hardware information from an operation system at which the target software is installed;
a hardware information control unit configured to apply the hardware information to the initial environment; and
a package generating unit configured to generate a software package from the initial environment to which the software information and the hardware information are applied.

2. The software packaging device according to claim 1,
wherein the environment setting unit is further configured to generate a plurality of preset basic folders to set the initial environment.

3. The software packaging device according to claim 2,
wherein the plurality of preset basic folders includes a binary folder, a device folder, a library folder, a variable folder, and a super binary folder.

4. The software packaging device according to claim 1,
wherein the software information control unit is further configured to extract meta information of the target software and extract from the target software the software information identical to software information recorded in the meta information.

5. The software packaging device according to claim 4,
wherein the software information control unit is further configured to migrate the software information to a basic folder set in the initial environment to be matched with a location of the software information extracted from the target software.

6. The software packaging device according to claim 1,
wherein the hardware information collecting unit is further configured to extract a call command provided to be performed by the target software and collect configuration information of the operation system called by the call command and profile information of the operation system required for operating the target software.

7. The software packaging device according to claim 1,
wherein the hardware information control unit is further configured to update the initial environment to which the software information is applied based on the hardware information collected from the operation system.

8. A software packaging method in a software packaging device for performing binary analysis, comprising:
by an environment setting unit, setting an initial environment;
by a software information control unit, extracting software information used by a target software and migrating and applying the software information to the initial environment;
by a hardware information collecting unit, collecting hardware information from an operation system at which the target software is installed;
by a hardware information control unit, applying the hardware information to the initial environment; and
by a package generating unit, generating a software package from the initial environment to which the software information and the hardware information are applied.

9. The software packaging method according to claim 8,
wherein the setting the initial environment comprises:
generating a plurality of preset basic folders to set the initial environment.

10. The software packaging method according to claim 9,
wherein the plurality of preset basic folders includes a binary folder, a device folder, a library folder, a variable folder, and a super binary folder.

11. The software packaging method according to claim 8,
wherein the extracting the software information and migrating and applying the software information to the initial environment comprises:
extracting meta information of the target software and extracting from the target software the software information identical to software information recorded in the meta information.

12. The software packaging method according to claim 11,
wherein the extracting the software information and migrating and applying the software information to the initial environment comprises:
migrating the software information to a basic folder set in the initial environment to be matched with a location of the software information extracted from the target software.

13. The software packaging method according to claim 8,
wherein the collecting the hardware information from the operation system comprises:
extracting a call command provided to be performed by the target software and collecting configuration information of the operation system called by the call command and profile information of the operation system required for operating the target software.

14. The software packaging method according to claim 8,
wherein the applying the hardware information to the initial environment comprises:
updating the initial environment to which the software information is applied based on the hardware information collected from the operation system.

15. A non-transitory computer-readable recording medium on which a computer program for performing a software packaging method is recorded, wherein the software packaging method comprises:
by an environment setting unit, setting an initial environment;
by a software information control unit, extracting software information used by a target software and migrating and applying the software information to the initial environment;
by a hardware information collecting unit, collecting hardware information from an operation system at which the target software is installed;
by a hardware information control unit, applying the hardware information to the initial environment; and
by a package generating unit, generating a software package from the initial environment to which the software information and the hardware information are applied.
